(19) United States
(12) Patent Application Publication
(10) Pub. No.: US 2009/0230836 A1
(43) Pub. Date: Sep. 17, 2009

(54) DISPLAY DEVICE AND PLASMA DISPLAY PANEL

(76) Inventors: Shin Imamura, Kokubunji (JP); Shunsuke Mori, Kokubunji (JP); Tatsuya Miyake, Tokorozawa (JP); Hideto Momose, Hitachiota (JP); Kazutaka Tsuji, Hachioji (JP); Ryo Inoue, Hitachinaka (JP); Shirun Ho, Tokyo (JP); Keizo Suzuki, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/391,387

(22) Filed: Feb. 24, 2009

(30) Foreign Application Priority Data
Mar. 13, 2008 (JP) JP2008-063918

(51) Int. Cl. H01J 63/04; G09G 3/28

(52) U.S. Cl. 313/485; 345/60

(57) ABSTRACT

Provided is a display device such as a plasma display device including a front plate and a rear plate arranged opposing to each other to form a discharge space, where a discharge gas filled inside the discharge space, and at least a pair of electrodes for performing a display discharge and a phosphor layer for emitting visible light by an ultraviolet ray emission by the discharge of the discharge gas are provided. Inside the discharge space, a material whose main composition is alumina oxychloride of a group IIa metal and/or a group IIb metal is at least partly contained. Accordingly, a sustain discharge voltage can be reduced.

### CROSS-REFERENCE TO RELATED APPLICATION

The present application claims priority from Japanese Patent Application No. JP 2008-063918 filed on Mar. 13, 2008, the content of which is hereby incorporated by reference into this application.

### TECHNICAL FIELD OF THE INVENTION

The present invention relates to a display device and a plasma display panel. More particularly, the present invention relates to a plasma display panel configured by using a phosphor excited by ultraviolet ray of a vacuum ultraviolet region to emit light and a display device provided with the plasma display panel.

### BACKGROUND OF THE INVENTION

In recent years, for display devices represented by a television set and a personal computer monitor, there has been a growing demand for thinning the device to make it unnecessary to have a large space to install. As the display device being able to accommodate thinning, a plasma display device (hereinafter, referred to as PDP (Plasma Display Panel) device), a field emission display (FED) device, and a liquid crystal display (LCD) device configuring a display device by combining a backlight and a thin liquid crystal panel have been vigorously developed.

Among these devices, the PDP device is a display device provided with a plasma display panel (hereinafter, referred to as PDP) as a light emission device. The PDP excites a phosphor in a phosphor layer arranged in its minute discharge space with a ultraviolet ray (when a Xenon gas is used as a rare gas, it is in the wavelength band of 146 nm and 172 nm) generated in a negative glow region at the minute discharge space containing a rare gas as an excitation source, and stimulates light emission from the phosphor, thereby obtaining light emission in the visible region. In the PDP device, the amount and the color of this light emission are controlled to be used for display.

In the PDP device, light emission and non-light emission in an image display of a cell (hereinafter, referred to as discharge cell) having an individual minute discharge space are adjusted by accumulated wall charges of discharge cells. The wall charges are adjusted by generating a discharge referred to as an address discharge before the light emission. Accordingly, it is very important to correctly generate the address discharge in the image display.

In addition, power consumption of the PDP device is increased and decreased depending on a discharge voltage at the time of performing the light emission. Further, the discharge voltage is involved also in the cost of a driving circuit. Hence, the discharge voltage is a very important factor in the performance of the PDP device.

In the PDP device, installation of a specific material inside the discharge space can give an effect to discharge characteristics and optical characteristics as described above. For example, characteristics of luminescent materials such as phosphor are important. Documents regarding this kind of materials and techniques include Japanese Patent Application Laid-Open Publication No. 2005-294255 (Patent Document 1), Japanese Patent Application Laid-Open Publication No. 2002-110051 (Patent Document 2), Japanese Patent Application Laid-Open Publication No. 2001-118511 (Patent Document 3), Japanese Patent Application Laid-Open Publication No. 2007-026793 (Patent Document 4), Japanese Patent Application Laid-Open Publication No. H11-191376 (Patent Document 5), Japanese Patent Application Laid-Open Publication No. 2005-026205 (Patent Document 6), and Japanese Patent Application Laid-Open Publication No. 2006-299098 (Patent Document 7).

### SUMMARY OF THE INVENTION

In recent years, as recognized for its high performance, the PDP device has been replacing monitors and television (TV) sets of the type employing a cathode-ray tube, and rapidly expanding its application as a large-sized flat panel display and a flat-screen TV. As a result, further performance improvement has come to be required. Specifically, for a high-definition television display by digital broadcasting and the like, high resolution is required. The number of display pixel lines required to be compliant with high-definition television display is 700 or more, and a large increase in resolution is required as compared with about 500 pixel lines compliant with the conventional broadcasting. However, when the number of display pixel lines exceeds the extent of 700 or more, the number of discharging cells is increased, and it increases load on the driving circuit and power consumption.

Further, since each display pixel becomes small for realizing higher resolution, higher luminance is also required, and high efficiency of the light emission for achieving higher luminance is also required. As one method for those, a study has been vigorously conducted, where a composition ratio of a Xe (xenon) gas in a discharge gas mainly containing Ne (Neon) is increased, and Xe₂ excimer radiation increased as a result is utilized for phosphor excitation. Although this is a technical trend of so-called “high concentration of xenon” in the PDP, a study is usually conducted to achieve such high efficiency of the light emission of the PDP in a composition ratio region higher than a Xenon gas composition ratio (about 5%) in the discharge gas. Particularly, in recent years, a trend is such that the xenon gas composition ratio is set to 8% or more at least, and the light emission is made highly efficient to maintain and improve luminance. However, the higher concentration of xenon brings about an increase of the discharge voltage. This increases load on the driving circuit and the like, invites a high cost as the device, and poses a reduction of a margin of the driving voltage, thereby making the driving difficult.

The PDP device has a further expanded type of usage as a flat TV device replacing TV devices using a cathode ray tube from just a flat-type display device. As a result, since demands for picture quality have been further increased to a higher level, as well as meeting an image quality improvement such as a reduction of flicker on a screen and demands for luminance, a power consumption reduction and a cost reduction must be achieved. For the purpose of power consumption reduction and cost reduction, a reduction of the discharge voltage becomes a major problem.

An object of the present invention is to improve image quality of the display device and the PDP and to improve efficiency of discharge.

The above and other objects and novel characteristics of the present invention will be apparent from the description of the present specification and the accompanying drawings.

The typical ones of the inventions disclosed in the present application will be briefly described as follows.

The present invention can solve the above-mentioned problem by a display device in which a front plate and a rear plate are arranged opposing to each other and forming a discharge space and a discharge gas is filled inside the discharge space, where at least one pair of electrodes for making a display discharge and a phosphor layer for emitting visible light by using ultraviolet ray emission by discharging the discharge gas are included, and a material to which charges are accumulated by voltage application or by light irradiation is contained inside the discharge space. Note that, in the present application, to contain the material in the discharge space means to include the case where the material is in contact with the discharge space.

In addition, according to the same display device as described above, the present invention can solve the above-mentioned problem by the display device including a material to which charges are accumulated and at least a part of the accumulated charges is held over a period of time longer than or equal to a pulse duration of a driving voltage waveform.

The problem can be solved by the display device in which a general example of the pulse duration of a driving voltage waveform is about 2 to 4 μs, and a material in which at least a part of the accumulated charges is held over a period of time of 2 μs or longer is included.

In addition, the above-mentioned problem can be solved by the display device including a material mainly containing aluminum oxychloride of a group IIa metal and/or a group IIb metal at least partially as a specific material of the material.

Further, if the material is a material whose main composition is expressed by MAl₂O₄ (where M is at least one element of Mg, C, Zn, and Sr), it is further effective.

Still further, if the material is a material containing a material whose main composition is expressed by Cal₂O₄ at least partially, it is particularly effective. At this time, CaAl₂O₄ exhibits particularly good characteristics when a crystal system of a main crystal phase is monoclinic and is in a space group P21. In the case of this crystal system, when an X-ray diffraction measurement by CuKα ray is performed, the diffraction line (main peak) having the highest intensity appears in the vicinity of 2θ=30°.

Note that, the compositions mentioned above are compositions of main components of the material, and some other elements may be contained.

In addition, when the material has a 15% or lower quantum efficiency of visible light emission in the range of 450 nm to 780 nm by irradiating ultraviolet ray 450 nm or below, the light emission display is less affected, and a further good image quality can be obtained.

Further, if a weight of the material being present inside the discharge space is not less than 0.1% and not more than 50% of a sum of the total weight of phosphors present inside the discharge space, it is further effective. Still further, if the weight range is not less than 1% and not more than 20%, it is further preferable.

Moreover, as a general value of the weight of the material present being inside the discharge space, the amount is preferably not less than 1 mg and not more than 220 mg per a panel area of 100 cm².

In the present invention, the material can be structured to exist in a layer of the phosphor for making the light emission display of visible light inside the discharge space.

In addition, as another configuration of the present invention, the material can be structured to be installed on barrier ribs and the front panel other than a layer of phosphor for making the light emission display of visible light inside the discharge space.

When these display devices are plasma display devices containing a gas that contains Xe gas by an amount to obtain a composition ratio in the discharge gas of 8% or more, the effect becomes further remarkable. Further, when these display devices are plasma display devices configured by 700 or more display pixel lines, the effect becomes further remarkable.

The effects obtained by typical aspects of the present invention will be briefly described below.

According to the present invention, as well as a high image quality of a display device and a PDP, a high discharge efficiency can be achieved.

### BRIEF DESCRIPTIONS OF THE DRAWINGS

FIG. 1 is an exploded perspective view of main parts of a PDP according to one embodiment of the present invention;

FIG. 2 is a cross-sectional view of the PDP along the line A-A in FIG. 1;

FIG. 3 is a cross-sectional view of the PDP along the line B-B in FIG. 1;

FIG. 4 is a cross-sectional view of the PDP along the line C-C in FIG. 1;

FIG. 5 is a diagram showing a sequence of voltages applied to respective electrodes in a subfield of an ADS method;

FIG. 6 is a diagram showing waveforms of driving voltages applied to an X electrode and a Y electrode in a sustain period;

FIG. 7A is a diagram showing a change in charging state upon sustain discharge and showing a state at the time point “a” in FIG. 6;

FIG. 7B is a diagram showing a change in charging state upon sustain discharge and showing a state at the time point “b” in FIG. 6;

FIG. 7C is a diagram showing a change in charging state upon sustain discharge and showing a state at the time point “c” in FIG. 6;

FIG. 7D is a diagram showing a change in charging state upon sustain discharge and showing a state at the time point “d” in FIG. 6;

FIG. 8 is a diagram showing a structure of a PDP device according to one embodiment of the present invention;

FIG. 9 is a diagram showing characteristics of a sustain discharge voltage of a display device according to one embodiment of the present invention;

FIG. 10 is a diagram showing luminance characteristics of the display device according to one embodiment of the present invention;

FIG. 11 is a diagram showing a relation between a weight of a material contained in the display device according to one embodiment of the present invention and characteristics of the sustain discharge voltage;

FIG. 12 is a diagram showing an X-ray diffraction measurement result of the material used in the display device according to one embodiment of the present invention;

FIG. 13 is a diagram showing a relation between a quantum efficiency and a chromaticity value of light emission of the material used in the display device according to one embodiment of the present invention;

FIG. 14 is a cross-sectional view of main parts of a PDP according to another embodiment of the present invention; and

FIG. 15 is a cross-sectional view of main parts of a PDP according to another embodiment of the present invention.

### DESCRIPTIONS OF THE PREFERRED EMBODIMENTS

Hereinafter, with exemplifying a typical one of embodiments of the present invention, an effect thereof will be described. The present invention will be effective even in a configuration other than the example shown below as long as the configuration brings the same effect. Note that, components having the same function are denoted by the same reference symbols throughout the drawings for describing the embodiment, and the repetitive description thereof will be omitted.

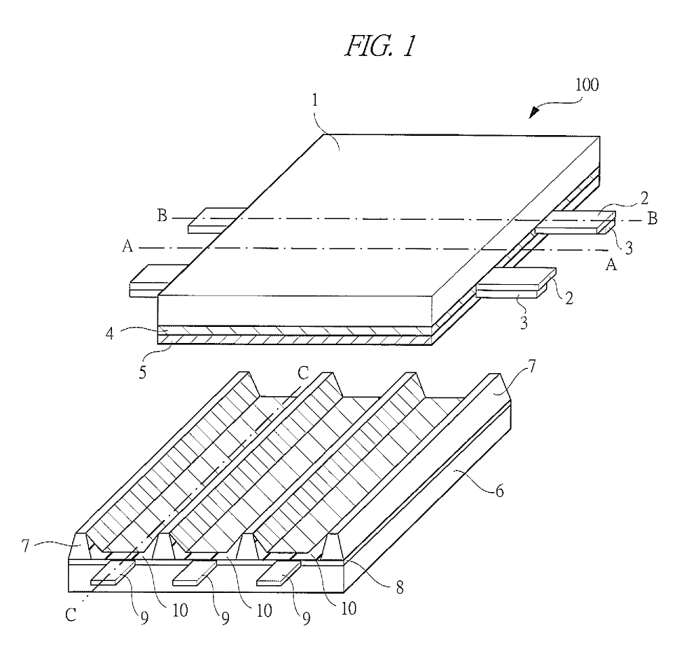

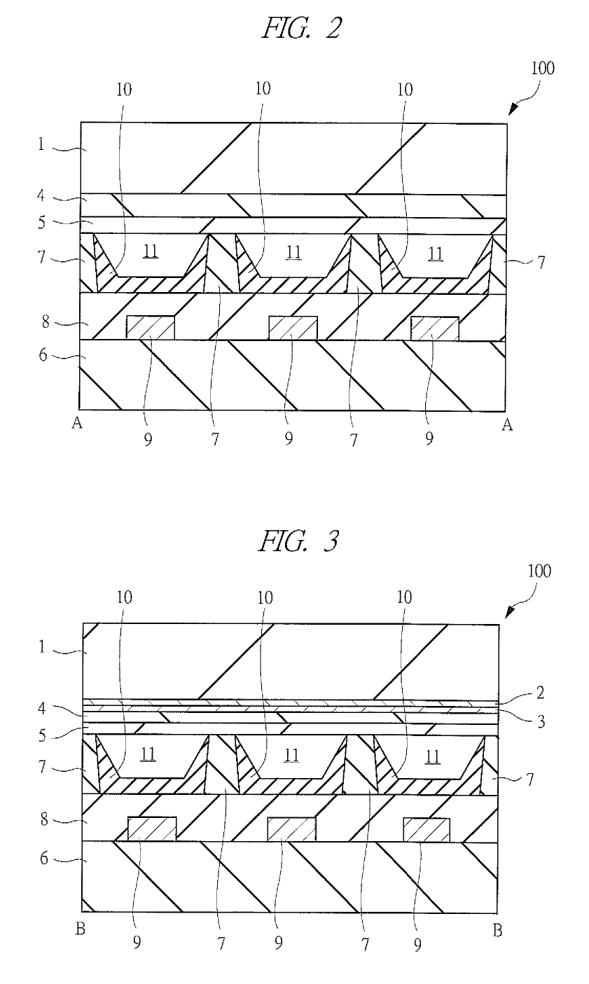

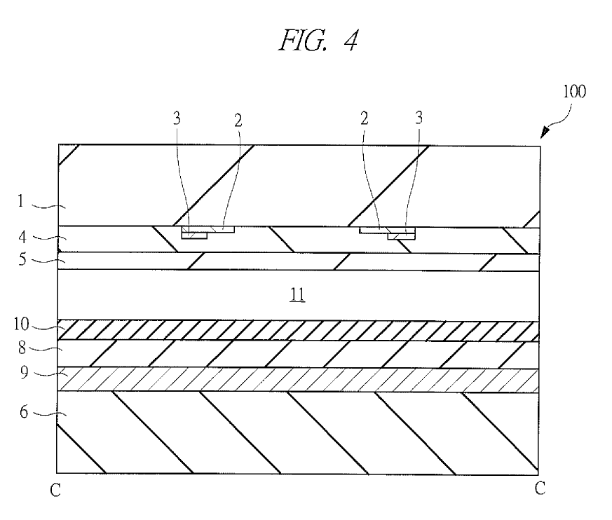

FIG. 1 is an exploded perspective view of main parts of a PDP 100 according to the present invention. FIG. 2, FIG. 3, and FIG. 4 are cross-sectional views of the PDP 100 along the lines A-A, B-B, and C-C after the PDP 100 shown in FIG. 1 is assembled, respectively. FIG. 2 shows a cross section along a direction in which an electrode 2 is extended, FIG. 3 shows another cross section along the direction in which the electrode 2 is extended, and FIG. 4 shows a cross section along a direction in which an electrode 9 is extended.

The PDP 100 has a structure corresponding to a so-called surface discharge type PDP (reflection type AC driving), and includes: a pair of substrates 1 and 6 isolated and arranged opposing to each other; a pair of electrodes 2, a bus line (bus electrode) 3, a dielectric layer 4, and a protective film 5 provided on the substrate 1; a barrier rib (rib) 7, a dielectric layer 8, an electrode 9, and a phosphor layer 10 provided on the substrate 6. Further, the PDP 100 includes a discharge gas (not shown) sealed (filled) inside a space (discharge space 11) formed between the pair of substrates 1 and 6 and generating ultraviolet ray by discharging. The discharge space in the PDP 100 is a space surrounded by the dielectric layer 8 and the protective film 5 after the pair of substrates 1 and 6 are superimposed, and the space is sectioned by the barrier ribs 7.

In the PDP 100, since the substrate 1 is a front plate serving as a display surface, the substrate 1 is formed of a substrate transmitting visible light emitted from the phosphor layer 10, and for example, is formed of high strain-point glass. Since the substrate 6 is a rear plate, the substrate 6 is not limited to a substrate transmitting visible light, but similarly to the substrate 1, it is formed of, for example, high strain-point glass.

The pair of electrodes 2 provided so as to extend in the predetermined direction on the substrate 1 configure a display electrode pair each including a scan electrode (hereinafter, referred to as Y electrode) and a sustain electrode (hereinafter, referred to as X electrode), and are formed of, for example, transparent electrodes such as ITO. The bus line 3 configuring the display electrode pair is an electrode narrow in width and low in resistance for compensating for an electrode resistance for the electrode 2 which is wide in width to improve the luminance, and is, for example, formed of Ag (silver) or Cu (copper)-Cr (chrome). The electrode 9 provided on the substrate 6 so as to extend in the direction crossing the direction in which the electrode 2 is extended configures an address electrode (hereinafter, referred to as A electrode), and is, for example, formed of Ag or Cu—Cr. Between the Y electrode and the A electrode, a write discharge is made in an address period, and between the Y electrode and the X electrode, a surface discharge is made for display in the sustain period (display period).

The dielectric layer 4 provided to cover the pair of electrodes 2 and the dielectric layer 8 provided to cover the electrode 9 accumulate wall charges generated by the write discharge in the address period on the surfaces thereof, and are formed of, for example, low melting-point glass. A voltage induced by the wall charges and a voltage applied during the sustain period generate a surface discharge, thereby making a discharge cell (display cell) to emit light.

The protective film 5 provided so as to cover the dielectric layer 4 reduces sputtering damages for the surface of the dielectric layer 4 upon discharging, and at the same time, the protective film 5 emits secondary electrons along with the surface discharge, and is formed of, for example, magnesium oxide (MgO).

The barrier ribs 7 provided for isolating each discharge cell and preventing color mixture with the adjacent discharge cells are formed of, for example, low melting-point glass. These barrier ribs 7 isolate the discharge cells, in other words, section the discharge spaces formed by the front plate (substrate 1) and the rear plate (substrate 6) arranged opposing to each other. In the PDP 100 of the present embodiment, though the barrier ribs 7 have a configuration of a linearly (stripe) shaped structure, they may have a rectangle configuration so as to section the respective discharge cells.

The barrier rib 7 and the phosphor layer 10 provided on the dielectric layer 8 between the barrier ribs 7 are formed of phosphors for performing the light emission display. That is, the phosphor forming the phosphor layer 10 is configured to be excited by vacuum ultraviolet rays having wavelengths of 146 nm and 172 nm which are generated from the discharge gas by the discharge, thereby emitting the visible light.

The phosphor layers 10 have separately provided thereto phosphors of three colors of red, green, and blue to perform the color display. As an example of the phosphor emitting the respective colors, (Y,Gd)BO₃:Eu phosphor for a red phosphor, Zn₂SiO₄:Mn²⁺ for a green phosphor, and BAM (BaMgAl₁₀O₁₇:Eu²⁺) phosphor for a blue phosphor can be cited. While it is often the case where these phosphors are used as a main component of each color, a material other than these phosphors may be used. Phosphors having an average grain size of 1 to 5 μm are often used, but the phosphor having a grain size other than that may be used.

While described in detail later, the discharge space in the present embodiment contains a material accumulated with charges by voltage application or by light irradiation, or a material accumulated with charges at least whose one part is held for a period of time longer than or equal to a pulse duration of a driving voltage waveform. For example, the phosphor layer 10 in contact with the discharge space contains alumina oxychloride of a group IIa metal and/or a group IIb metal together with the phosphor, specifically, MAl₂O₄ (where M is at least one element out of Mg, Ca, Zn, and Sr). Thereby, a high image quality of the PDP 100 and a high efficiency of the discharge can be achieved.

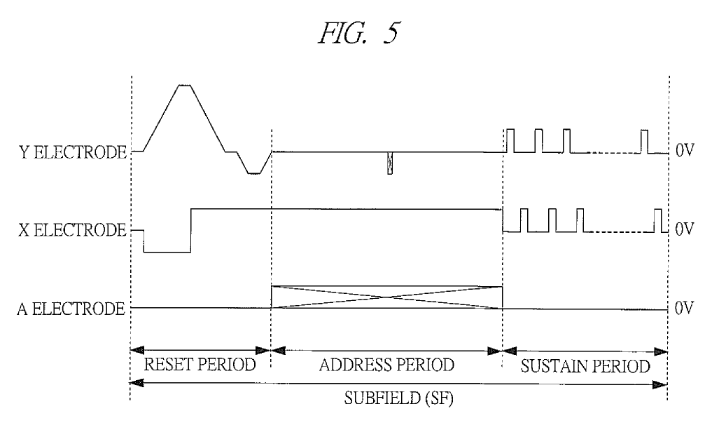

Here, as an example of a grayscale display method of the PDP 100 in the present embodiment, a case where an ADS (Address Display-Period Separation) method is applied will be described. FIG. 5 is a diagram showing a sequence of voltages applied to respective electrodes in a subfield (SF) of the ADS method. In FIG. 5, a reference voltage (reference potential) is set to 0 V.

The subfield shown in FIG. 5 is one of those obtained by dividing a field (16.67 ms) into a plurality of subfields having a predetermined luminance ratio. In the ADS method, the plurality of subfields are made to selectively emit light corresponding to images, thereby expressing grayscale by differences in luminance. One subfield, as shown in FIG. 5, is configured by a reset period, an address period, and a sustain period.

In the reset period, a voltage exceeding a firing voltage is applied between the display electrodes, and a rest discharge is generated at all the discharge cells. Thereby, wall voltages inside all the discharge cells can be uniformed.

In the address period, a voltage is applied to the A electrode and the Y electrode of discharge cells selected based on image data. The Y electrode of the selected discharge cell is applied with a scan pulse of a predetermined negative voltage, and synchronizing with this, a predetermined positive voltage (address voltage) is applied to the A electrode, so that an address discharge (select discharge) is made. In the discharge cell (serving as a display cell) in which the selected address discharge is made, the dischargeable wall charges are accumulated upon making the display discharge performed in the sustain period. The A electrode of the discharge cell (serving as a non-display cell) not serving as a display cell is not applied with the address voltage, and the address discharge is not made. Hence, the wall charges are not generated in the non-display cell, thereby not making the display discharge in the sustain period.

In the sustain period, a sustain pulse is alternately applied to the Y electrode and the X electrode, so that a sustain discharge (display discharge) is made. For example, when ten subfields having a weighting of luminance based on the binary system are provided, the discharge cells of red (R), green (G), and blue (B) obtain a luminance display of 2¹⁰ (=1024) grayscales, and a color display of about 1,073,740,000 colors is made possible.

The Y electrode and the X electrode are configured by a pair of the adjacent electrodes 2 in FIG. 1, and a light emission display is performed by a discharge (sustain discharge) between these two electrodes. The voltage for the sustain discharge is simultaneously applied to all the discharge cells. Hence, it is necessary to select the discharge cells to make the discharge and emission and the discharge cells not to make the emission. This selection is performed by making a discharge between the A electrode and the Y electrode. The A electrode is the electrode 9 in FIG. 1.

In the case of selecting the discharge cells to emit, the voltage is simultaneously applied to the A electrode and the Y electrode intersecting the A electrode. Only in the discharge cells simultaneously applied with the voltage, the discharge (address discharge) is generated between the A electrode and the Y electrode. At this time, charges are accumulated inside the discharge cells. The voltage between the Y electrode and the X electrode is set to a voltage which does not start the discharge alone. Only when the voltage by the accumulated charges is added to the voltage between the Y electrode and the X electrode, the discharge is started. Therefore, only by the discharge cells to which the address discharge is made, light emission by the discharge occurs, thereby forming the image.

Further, since the discharge cell once formed with the wall charges keep generating the sustain discharge subsequently, it is necessary to eliminate the wall charges not to allow the discharge cell to emit. Accordingly, before applying a voltage of an address discharge, a voltage for eliminating the wall charges is applied on all the discharge cells. This is a reset voltage, and the time for applying this reset voltage is a rest period.

A voltage application sequence shown in FIG. 5 is provided for a period referred to as a subfield. One image is formed by a period referred to as one field. To provide differences of luminance to respective pixels forming one image, one field is divided into, for example, around ten subfields, and a series of discharges are made by the respective subfields.

A main object of the configuration of the present invention is to improve the efficiency of discharge and to reduce load on a driving circuit by reducing the voltage of the sustain discharge. By adopting the configuration of the present invention, the voltage firing the sustain discharge can be made lower than the conventional voltage.

Some examples on the contributing factors of the effect of the present invention will be described in the following. Note that, the factor cited here is one example, and in the present invention, the effect may be given by another factor. The present invention includes not only the effect by the example cited here, but also an effect by another factor obtained by a material satisfying the requirements of the present invention. Further, the following description is schematic, and mathematical expressions and the like described in figures and texts are not necessarily represent exact numerical values.

A first example of an explanation on the factor of the present invention will be described. The sustain discharge voltage of the PDP 100 is mainly decided by easiness of electron discharge from the protective film 5, which is formed of, for example, MgO. In the case of the present invention, since the material of the protective film 5 is the same, it is not that the characteristic of electron discharge from the protective film 5 itself is altered. Accordingly, it is conceivable that the discharge voltage is reduced by an increase of the amount of positive ions or the amount of electrons inside the discharge space close to the protective film 5. The electron discharge from the protective film 5 is mainly caused by an incidence of positive ions ionized by the discharge gas on the protective film 5. Hence, as the positive ions close to the surface of the protective film 5 are increases, the electron discharge becomes easy. Further, when the amount of the electrons existing in the discharge space is increased, these electrons collide with the discharge gas so as to be ionized at the time of applying the voltage, so that the number of positive ions is also increased. Therefore, also in this case, the electron discharge becomes easy.

To bring in the above described effects, the material of the present invention is required to satisfy the following features. First, 1) the charges are accumulated by voltage application or by light irradiation to generate positive charging or negative charging. By using such a material at the portion other than the protective film 5 of the discharge position, positive ions repulse in the case of the positive charging, and electrons repulse in the case of the negative charging, to move in the direction to back away from this material. That is, they get close to the protective layer 5 of the discharge position, and as a result, the amount of positive ions or the amount of electrons in the discharge space close to the surface of the protective film 5 is increased.

Next, 2) the above-described effects become greater if the charges accumulated in the material of the present invention are held for a certain period of time or longer. That is, at least a part of the accumulated charges is preferably held for a period of time longer than or equal to a pulse duration of a driving voltage waveform. This period of time is around 2 to 4 μs for a typical drive waveform. In the pulse duration of the driving voltage waveform, the sustain discharge is made once. As the charges are maintained within this period, the movement of positive ions or electrons becomes remarkable, and so it is more effective.

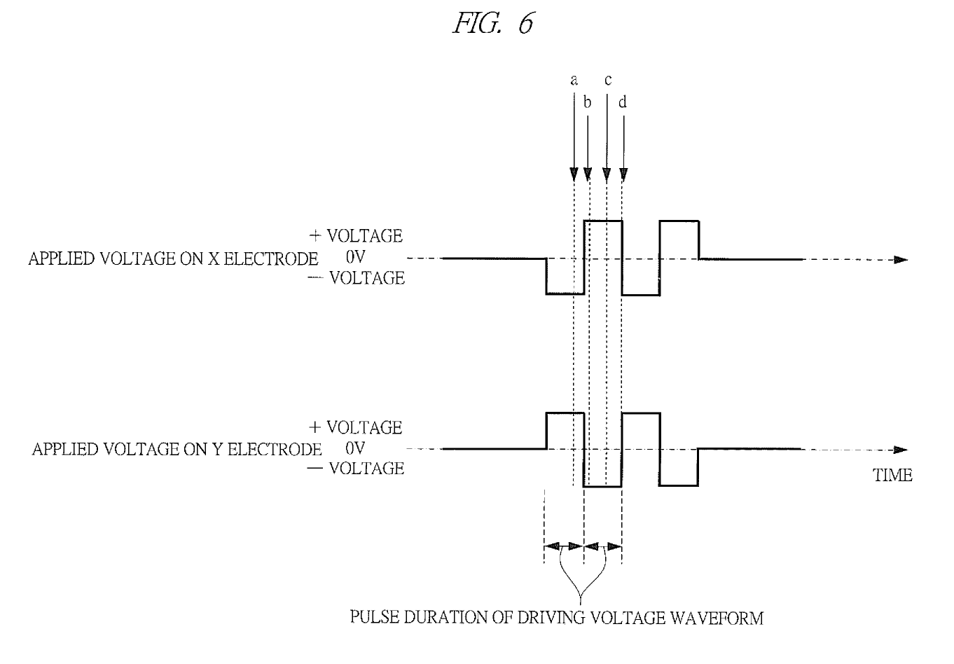

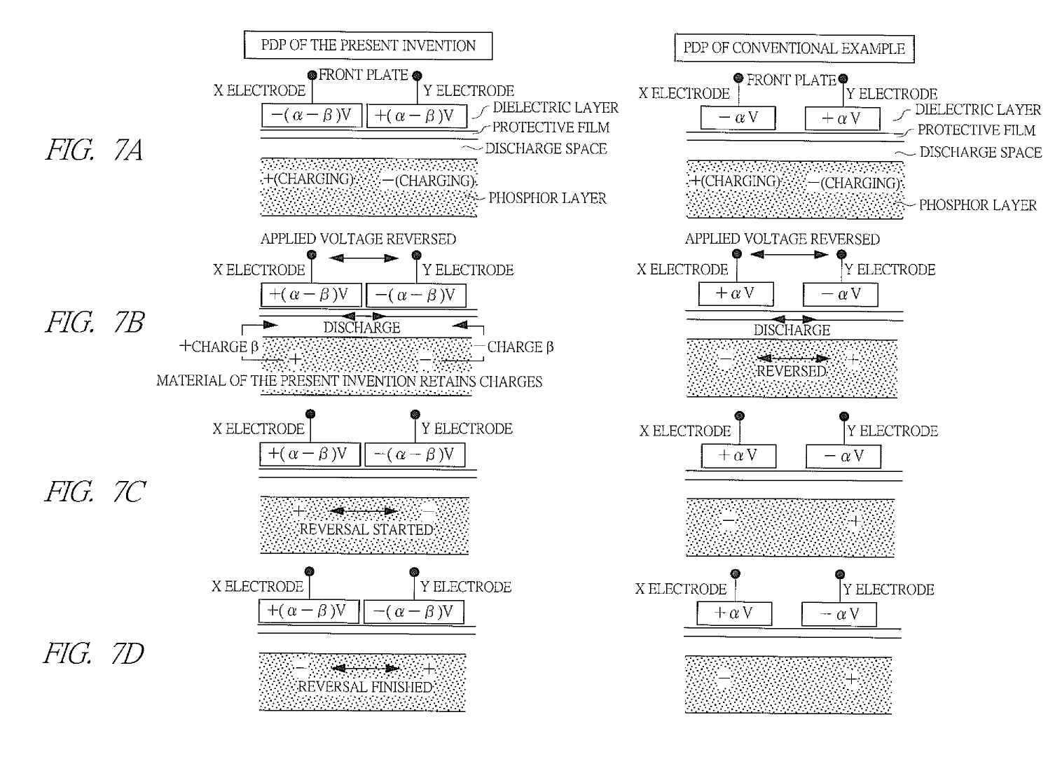

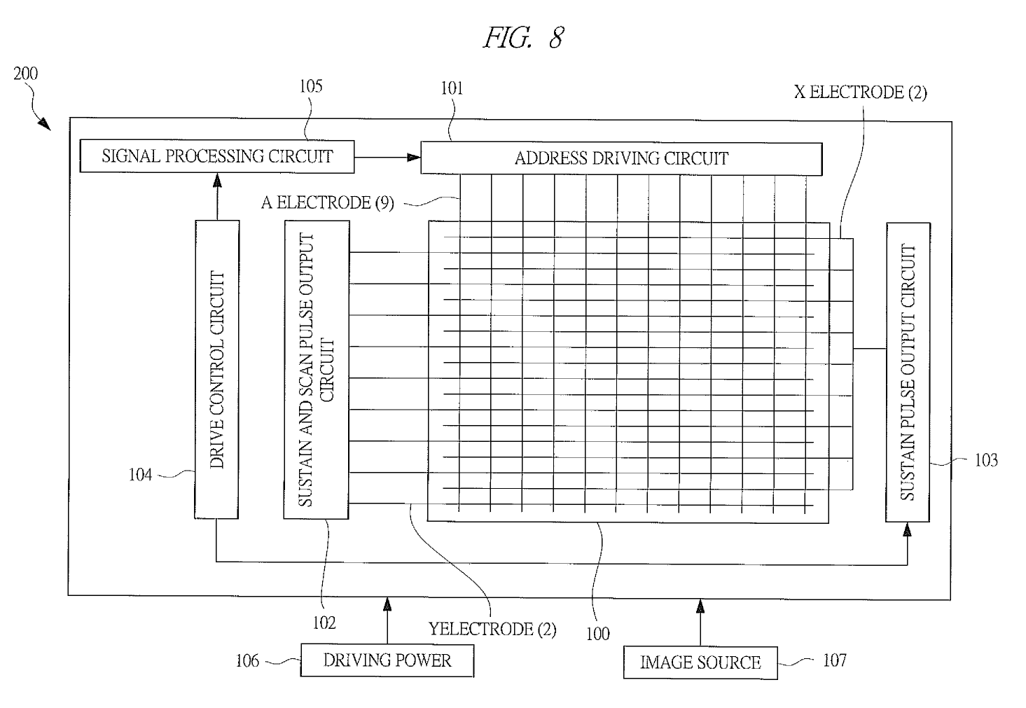

A second example of the explanation on the factor of the present invention will be described. As another factor different from the above explanation, the case where the charging of the material of the present invention directly brings in the effect as a voltage will be described with reference to FIG. 6 and FIGS. 7A, 7B, 7C, and 7D. FIG. 6 is a diagram showing waveforms of driving voltages to be applied to the X electrode and the Y electrode at the sustain discharge time. FIGS. 7A, 7B, 7C, and 7D are diagrams each showing a change of a charging state upon a sustain discharge and showing states at the time points of a, b, c, and d in FIG. 6, respectively.

In each of FIGS. 7A, 7B, 7C, and 7D, there is shown movement of the charges inside a PDP cell at the sustain discharge when the PDP performs a light emission display, and a comparison between the present invention and a conventional example is conducted. Here, in the present invention, the phosphor is mixed with a material which satisfies the requirements of the present invention. In the conventional example, only an ordinary phosphor is used. These phosphors are applied to the inner sides of the barrier ribs inside the cells, and the phosphors are present up to directly below the X electrode and the Y electrode.

The driving voltage in the present invention is lower by β, and the driving voltage of the present invention is taken as (α-β) V, and that of the conventional example is taken as α V. FIG. 7A shows a state in which the X electrode is applied with a negative voltage and the Y electrode is applied with a positive voltage, and the state is immediately before reversing the applied voltage for driving. At this time, a voltage is generated in the phosphor to negate this state, and the part underneath the X electrode is positively charged and the part underneath the Y electrode is negatively charged. This holds true for both the present invention and the conventional example even a difference in charging amount exists.

In FIG. 7B, there is shown a state in which the applied voltage is reversed for driving, and the X electrode is applied with a positive voltage and the Y electrode is applied with a negative voltage. At this time, in the conventional example, simultaneously with the reversal of the applied voltage, the charging is also reversed, and the part underneath the X electrode becomes negative and the part underneath the Y electrode becomes positive. On the other hand, in the present invention, since the material mixed with the phosphor holds the charging, a state similar to the state of FIG. 7A is maintained, and the part underneath the X electrode remains positively charged and the part underneath the Y electrode remains negatively charged.

Although the discharge is started in this state, the charging of the phosphor is reversed to have a potential in the direction to negate the applied voltage in the conventional example. Here, only when the applied voltage becomes α V, the charging exceeds the discharge voltage, so that the discharge is started. In contrast to this, in the present invention, since the charging of the material mixed with the phosphor is not reversed, it becomes to have a potential in the direction to be added to the applied voltage. Here, the voltage to be added is β, and hence, in the present invention, the applied voltage is (α-β) V to exceed the discharge voltage, so that the discharge is started.

FIG. 7C shows a state after the discharge. At this point, the present invention generates the reversal of charging of the material mixed with the phosphor. On the other hand, the conventional example has no change in the charging.

FIG. 7D shows a state immediately before a next applied voltage reversal after the discharge. At this time, the present invention almost finishes a reversal of the material mixed with the phosphor, and the charging becomes almost in the same state as the conventional example. This is a state in which the polarity of the voltage is reverse to the state of FIG. 7A, and in the next applied voltage reversal, the discharge is generated by the similar changes while polarities thereof are opposite to those of the states of FIG. 7A to 7D. This process is repeated, so that the sustain voltage is driven.

According to the foregoing, in the present invention, it is clear that the driving voltage can be reduced by a voltage β V added by the charging of the material mixed with the phosphor. Note that, while the description has been made that the material of the present invention can be both positively and negatively charged, even when the material is charged either positively or negatively, the same effect can be obtained. The charging of the material may be either positive charging only or negative charging only.

To bring in the above-described effects, the material of the present invention is required to satisfy the following features. 1) The charges are accumulated by voltage application or by light irradiation. 2) At least a part of the accumulated charges is held for a period of time longer than or equal to the pulse duration of the driving voltage waveform. This period of time is around 2 to 4 μs in the typical drive waveform.

Such an effect does not depend on the kind of the phosphor. While an example where the material is mixed with the phosphor has been shown, as long as the material brings in the same effect, the way of installing the material may be another way. For example, it may be installed as a lower layer of the phosphor. In addition, it may be installed as the barrier rib itself. Further, it may be installed on the inner side of the front plate.

The charge accumulation of the material bringing in such an effect can be easily confirmed by checking the charging amount immediately after the panel discharge. An example of an estimation method will be described. As a measuring device, an electrostatic voltmeter and the like are employed, and a measuring probe is placed on a rear side of the panel, and a change of electrostatic potential immediately after the discharge is measured. When the material of the present invention is used, the potential and the retention time are different from those of the conventional case.

As still another factor of the present invention, when the material of the present invention is a material emitting electrons, the effect of the present invention can be made further effective.

To reduce the voltage of the discharge, it is necessary to increase the number of electrons existing in the discharge space. Although the emission of electrons into the discharge space is mainly performed from the protective film 5, by including another material for discharging electrons, the number of electrons can be increased. Particularly, when the material which accumulates charges used in the present invention further discharges electrons, since the accumulated charges contribute to the discharge, it is particularly effective.

Here, a definition of the material emitting electrons and an effect on the discharge will be described with reference to FIGS. 1 to 4. The material for emitting electrons means a material which makes a voltage to start a gas discharge by applying a negative voltage on the electrode 9 on the phosphor side and applying a positive voltage on the electrode 2 provided at a position away from the electrode 9 interposing a space for making the gas discharge to be lower in the case where the electron-emitting material is contained in the phosphor layer 10 than the case where the electron-emitting material is not present in the phosphor layer 10. At this time, a main phosphor contained in the phosphor layer 10 is, for example, ZnSiO₄:Mn and the like.

In addition, to show one example in the present invention specifically, in the case where a material for emitting electrons whose composition is expressed by CaAl₂O₄ is contained in the phosphor layer 10 by the amount of 5 to 30 wt % based on the total weight of the material constituting the phosphor layer 10, the voltage to start a gas discharge by applying a negative voltage on the electrode 9 on the phosphor side and applying a positive voltage on the electrode 2 provided at a position away from the electrode 9 interposing a space for making the gas discharge becomes 5 to 30 V lower than the case where the material emitting electrons whose composition is expressed by CaAl₂O₄ does not exist in the phosphor layer 10. Note that, the lowered voltage and the weight percent of the material for emitting electrons are not necessarily in a proportional relation, and there is also a case where a great effect can be obtained even by small amounts.

An effect on things other than the sustain discharge of the present invention will be also described. Electrons existing in the discharge space repulse from the electrode to which a negative voltage is applied, and move to the electrode side to which a positive voltage is applied through the discharge space, thereby allowing the discharge to start. Hence, when the material for emitting electron is provided in the vicinity of the electrode to which the negative voltage is applied, the firing voltage can be effectively reduced. When the material for emitting electrons of the present invention is used in, for example, the phosphor layer 10, as described above, the voltage to start a gas discharge by applying a negative voltage on the electrode 9 on the phosphor side and applying a positive voltage on the electrode 2 provided at a position away from the electrode 9 interposing a space for making the gas discharge in the case where the electron-emitting material is contained in the phosphor layer 10 is lowered.

Such a discharge becomes different from the sustain discharge used mainly for the light emission display, and in the driving, it is sometimes used for the reset discharge.

In the plasma displays, for the purpose of a charge adjustment, the reset discharge is required at least once in several fields. By this rest discharge, the luminance in black display is increased and that leads to a reduction of contrast.

As described above, the rest discharge voltage can be reduced by the present invention. Consequently, the light emission intensity by the rest discharge can be reduced, the luminance in black display can be reduced, and the contrast can be improved.

In this manner, by the present invention, a contrast improvement which is an important subject in the plasma display panels can be achieved, and a high quality image plasma display panel can be fabricated.

FIG. 8 is a diagram showing a configuration of a PDP device 200 according to the present invention. The PDP device 200 includes the PDP 100 having the A electrode (electrode 9), the Y electrode (one of a pair of electrodes 2), and the X electrode (the other one of the pair of electrodes 2), an address driving circuit 101 for driving the A electrode, a scan/sustain pulse output circuit 102 for driving a scan/sustain electrode (Y electrode 23), a sustain pulse output circuit 103 for driving a sustain electrode (X electrode 22), a drive control circuit 104 for controlling these output circuits, and a signal processing circuit 105 for performing a processing of an input signal. Further, the PDP device 200 is provided with a drive power supply 106 for applying a voltage to the PDP 100 etc. and an image source 107 for generating an image signal.

The PDP device 200 joins the electrodes of the PDP 100 and a flexible substrate by an anisotropic conductive film. After that, to improve heat dissipation of the PDP 100, for example, a plate of such as aluminum is attached, and on this plate, driving circuits such as the drive power supply 106 and the address driving circuit 101 are mounted, thereby completing a plasma display module. After that, an inspection is further conducted, and an exterior casing is attached, thereby completing a plasma display device 200.

As shown in FIG. 1, the PDP 100 has provided therein the electrode 9 configuring the A electrode on the rear plate (substrate 6), and a pair of electrodes 2 configuring the Y electrode and the X electrode on the front plate (substrate 1). The space (discharge space 11) sandwiched by the front plate and the rear plate is sectioned by the barrier ribs 7, and each sectioned space forms a discharge cell. A discharge gas is sealed in the discharge space 11, and when a voltage is applied to the Y electrode and the X electrode, a sustain discharge is made, thereby generating ultraviolet ray. Each of the discharge cells is coated with a phosphor which emits red, green or blue, and by the ultraviolet ray generated as described above, this phosphor is excited and emits light colored corresponding to the phosphor. By utilizing this light emission, a discharge cell of the desired color is selected according to the image signal, so that a color image display can be performed.

The present invention, when applied in a PDP device including a gas containing Xe gas by the amount whose composition ratio of the discharge gas becomes 8% or more, reduces the discharge voltage increased by the high xenon concentration, so that the driving becomes easy, and so it is particularly effective. Further, the present invention, when applied in a PDP device configured by 700 pixel lines or more, reduces the discharge voltage, thereby reducing load on a driving circuit, and suppressing power consumption low, and therefore, it is particularly effective.

Embodiments of the present invention will be described in detail in the following based on the drawings.

### FIRST EMBODIMENT

A PDP 100 and a PDP device 200 using the PDP 100 according to a present embodiment will be described with reference to FIGS. 1 to 4 and FIG. 8. In the present embodiment, a material satisfying the requirements of the present invention is mixed with phosphors of red, green, and blue to constitute a phosphor layer 10.

As an example of the material satisfying the requirements of the present invention, aluminum oxychloride of a group IIa metal and/or a group IIb metal, particularly, CaAl₂O₄, MgAl₂O₄, ZnAl₂O₄, SrAl₂O₄, Sr₄Al₁₄O₂₅, etc. can be cited. Further, mixed crystals of these materials can be also employed. Among these materials, at least one kind is mixed in a range of 0.1 wt % to 80 wt %, so that the PDP 100 shown in FIG. 1 can be fabricated. Although a material composition is exemplified above, the materials to be mixed are not limited thereto, and as long as the characteristics satisfying the condition of the present invention is obtained, an employment of a material other than those described here is effective. The composition described above is a composition of a main component of the material, and few other elements may be contained.

In addition, as the phosphors of three colors of red, green, and blue, (Y,Gd)BO₃:Eu phosphor for a red phosphor, Zn₂SiO₄:Mn²⁺ phosphor for a green phosphor, and BAM (BaMgAl₁₀O₁₇:Eu²⁺) phosphor for a blue phosphor are used as a main component of each color. Note that, the effect of the present invention is effective even when materials other than these materials are used for the main component of each color of the phosphor.

In the PDP 100 of a surface discharge type color PDP device described in the present embodiment, for example, one (generally referred to as scanning electrode) of a pair of display electrodes (electrode 2) is applied with a negative voltage, and an address electrode (electrode 9) and the other remaining display electrode (electrode 2) are applied with a positive voltage (positive voltage as compared with the voltage applied to the display electrode) so that a discharge is generated, thereby wall charges serving as an auxiliary for starting the discharge between the pair of display electrodes are formed (this is referred to as writing). When a suitable reverse voltage is applied between the pair of display electrodes in this state, a discharge is generated in a discharge space 11 between the pair of display electrodes (electrodes 2) via a dielectric layer 4 (and a protective film 5).

After terminating the discharge, when the voltage applied to the pair of display electrodes (electrodes 2) is reversed, a new discharge is generated. By repeating this, the discharge is continuously generated (this is referred to as a sustain discharge or a display discharge).

A method for manufacturing the PDP 100 shown in the present embodiment and the PDP device 200 using the PDP 100 will be described. First, on a rear plate (substrate 6), the address electrode (electrode 9) formed of Ag (silver) and the like and the dielectric layer 4 formed of a glass-based material are formed, and after that, a barrier rib material similarly formed of a glass-based material is thick-film printed, and a barrier rib 7 is formed by a sandblasting using a blast mask.

Subsequently, respective phosphor layers 10 of red, green, and blue are formed on this barrier rib in sequence in a stripe-like shape to cover groove surfaces between the corresponding barrier ribs 7.

Here, respective phosphor layers 10 correspond to red, green, and blue, where a red phosphor particle is 40 pts.wt. (60 pts.wt. for a vehicle), a green phosphor particle is 40 pts.wt. (60 pts.wt. for a vehicle), and a blue phosphor particle is 35 pts.wt. (65 pts.wt. for a vehicle), and each particle is mixed with the vehicle and is made into a phosphor paste, which is coated by screen printing, and after that, by drying and burning processes, evaporation of volatile components and combustion removal of organic materials inside the phosphor paste are performed, thereby forming the phosphor layer. The respective phosphor layers 10 shown in the present embodiment are formed of the respective phosphor particles having a central grain size of about 3 μs.

Subsequently, a front substrate (substrate 1) formed with the display electrode (electrode 2), a bus line 3, the dielectric layer 4, and a protective film 5 and a rear substrate (substrate 6) are frit-sealed, and the interior of the panel is vacuum-exhausted, and after that, a discharge gas is injected and sealed. The discharge gas is a gas containing xenon (Xe) gas by the amount whose composition ratio is 10%.

Subsequently, by assembling driving circuits and the like for driving the PDP 100, the PDP device 200 which is a display device configured to perform an image display as shown in FIG. 8 can be fabricated by using the PDP 100.

This PDP device 200 has a low sustain discharge voltage, and a high discharge efficiency, and moreover, it can be made into a low-cost device having low loads to the driving circuit.

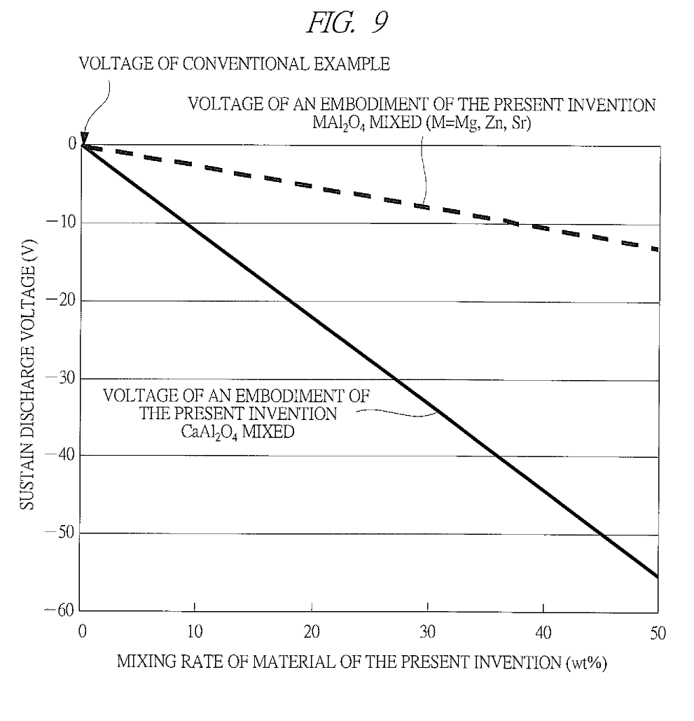

FIG. 9 shows the sustain discharge voltage of the PDP device 200 (PDP 100). Here, as the material satisfying the requirements of the present invention, an example using CaAl₂O₄, MgAl₂O₄, ZnAl₂O₄, and SrAl₂O₄ is shown. In FIG. 9, an axis of abscissa indicates a weight mixing ratio of the material of the present invention for phosphor, and an axis of ordinate indicates a changed amount of the sustain discharge voltage. Here, the sustain discharge voltage of the conventional example which does not contain the material of the present invention is taken as 0.

As shown in FIG. 9, it can be read that the sustain discharge voltage is reduced by the mixing of the materials. While the voltage reduction effect is seen in each material, it is clear that the effect is particularly remarkable in CaAl₂O₄. From FIG. 9, it follows that the effect is recognized when the above material (CaAl₂O₄) is contained in the amount of 0.1 wt %, and when it is contained in the amount of 1 wt % or more, the effect reaches to a significant level. When the material (CaAl₂O₄) is contained by the amount of 5 wt % or more, several volts or more of the discharge voltage can be reduced. According to FIG. 9, when only the discharge voltage is considered, the effect becomes more remarkable when the mixing amount is more. At least, the reduction voltage increases up to about 50 wt % of the mixing amount. That is, a particularly effective mixing range is about 0.1 wt % to 50 wt %.

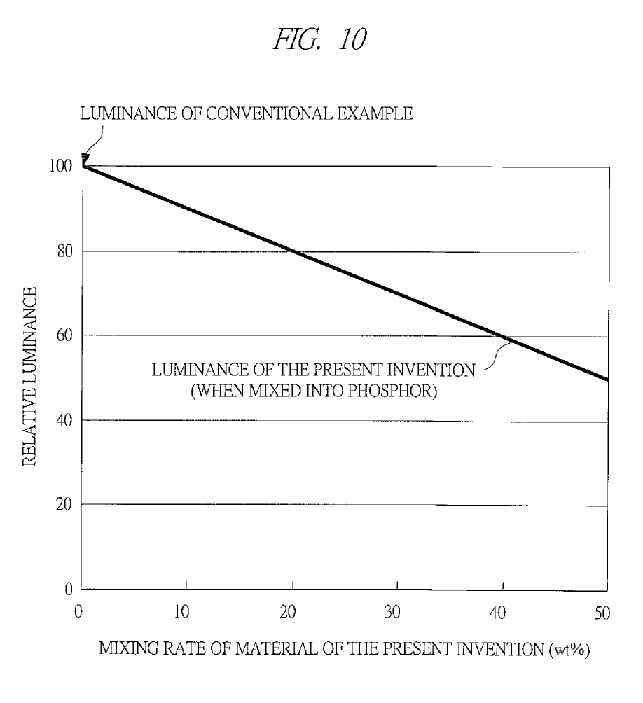

On the other hand, the emission luminance is reduced when the mixing amount is increased. FIG. 10 shows a luminance when the material of the present invention is mixed with all the phosphors of red, green and blue. The luminance of the PDP device 200, when reduced to about 80% or below, seriously affects the image quality. From FIG. 10, it follows that when the material of the present invention is contained by an amount of 20 wt % or more, the luminance of the PDP device 200 is reduced to about 80% or more. Consequently, more effectively, the material may be preferably contained by the amount of 1 wt % to 20 wt %.

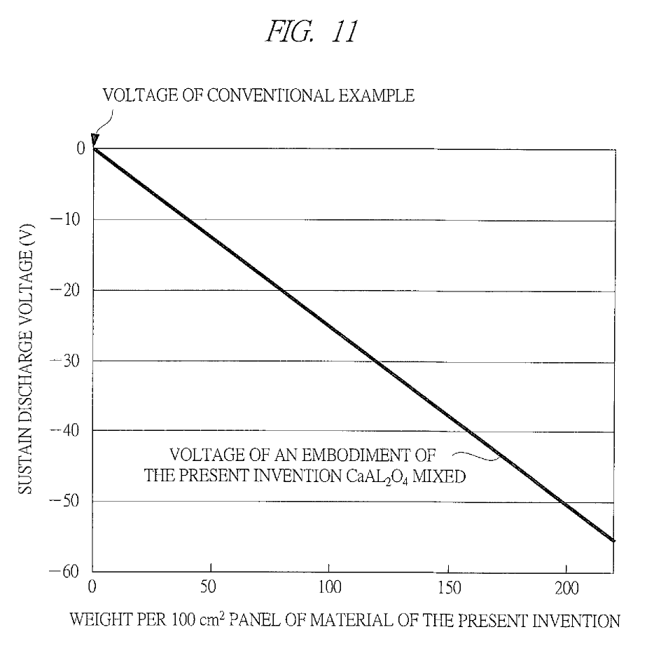

In addition, in the general plasma display panels, the weight of the material of the present invention contained by mixture in the phosphor is preferably not less than 1 mg and not more than 220 mg per a panel area of 100 cm². In FIG. 11, with taking CaAl₂O₄ as an example, a relation between the weight of the material of the present invention per a panel area of 100 cm² and the sustain discharge voltage is shown. When the material of the present invention is contained by the amount of 1 mg or more, the effect is recognized, and at least up to about 220 mg, the reduced voltage is increased.

Note that, the mixing ratio or the weight per the panel area of 100 cm² cited above is an effective range when it is structured to have the material of the present invention existing in the phosphor layer 10 for performing the emission display of the visible light inside the discharge space 11, and in the case otherwise, it is sometimes more effective when the material is used out of the range.

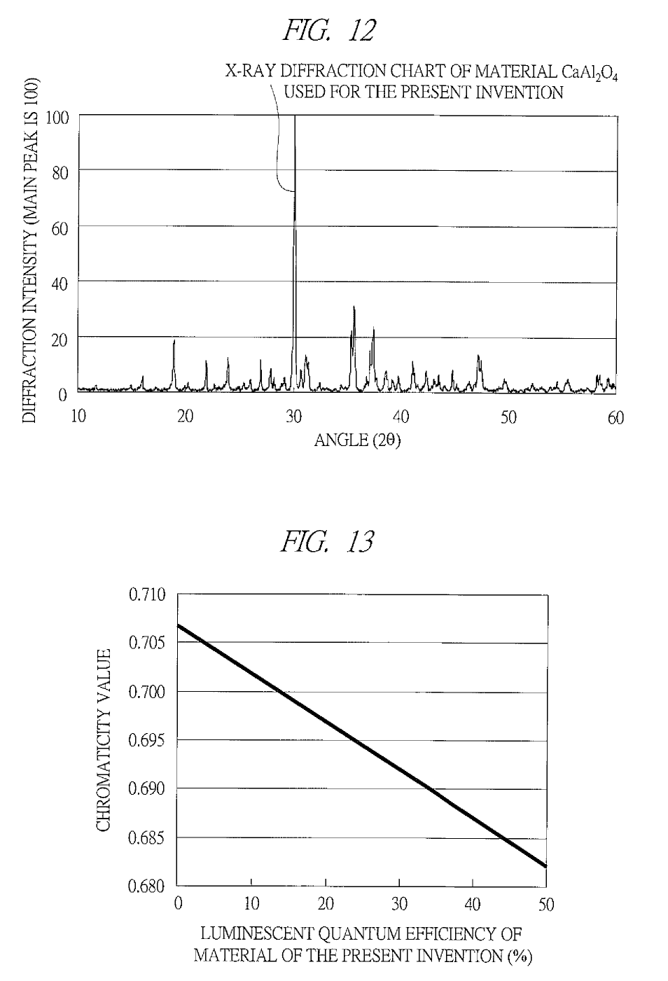

CaAl₂O₄ used here particularly exhibits good characteristics when the crystal system of the main crystal phase is monoclinic and in a space group P21. FIG. 12 shows an example of an X-ray diffraction measurement result by θ-2θ scan by CuKα-ray of CaAl₂O₄ used in the present invention. It is read that the diffraction line (main peak) having the strongest intensity appears in the vicinity of 2θ=30°. This measurement can be performed by a general-purpose powder X-ray diffraction device.

Further, the above material may emit light by excitation of ultraviolet rays and the like by adding other elements or defects in the crystal and deviation in composition. As a result of a study, it is found that the voltage reduction effect of the present invention is effective regardless of emission or non-emission. However, in the PDP, since the light emission of the phosphor for performing the light emission display is adjusted for a good color reproduction and a moving image display, if another emission is added, an adverse effect may be often exerted. Citing one example, by adding Eu (europium) to the composition of CaAl₂O₄, bluish-purple color is emitted. If this material is made to emit simultaneously with the green phosphor of the PDP, a green light emission is mixed with the bluish-purple light emission, so that the color reproduction of the green light emission is reduced.

CaAl₂O₄ having the composition to which Eu is added obtains ones different in quantum efficiency of light emission due to the differences in compositions. With respect to CaAl₂O₄ changing the quantum efficiency and adding Eu to the composition mixed with a normal green phosphor by a weight percent of 50 wt %, a change in chromaticity value of the light emission was estimated. The light emission by ultraviolet rays is measured by a luminance meter capable of measuring chromaticity, and a chromaticity values y of CIE: x-y chromaticity coordinate system were compared. In FIG. 13, the estimation result is shown. It is read that the chromaticity value y of the axis of ordinate is reduced as the quantum efficiency of the mixed materials of the present invention is increased. This result shows that, when the quantum efficiency is increased, the amount of the bluish-purple light emission is increased and affects the green light emission color.

In the light emission of the green phosphor, if the chromaticity value y is a value exceeding 0.7, it is green with a good color reproducibility, and conversely, if the chromaticity value y is lower, it is a green with a bad color reproducibility. In the case of the plasma display, the chromaticity value y is preferably 0.7 or more. From FIG. 13, it is read that, if the quantum efficiency is about 15% or lower, the chromaticity value y becomes 0.7 or more, so that good color reproducibility can be maintained. Accordingly, it is preferable to make the material of the present invention have a quantum efficiency of light emission lower than or equal to 15%.

The light emission concerned here is only the visible light which affects the display representation. Hence, the quantum efficiency of the visible light emission in a range of 450 nm to 780 nm by ultraviolet ray irradiation of 450 nm or under was used. Note that, the quantum efficiency of the light emission of the material can be measured by a quantum efficiency measuring device commercially available.

In addition, while a tendency to increase the sustain discharge voltage has been observed when the Xe concentration is 8% or more in the PDP, even when the Xe concentration is 8% or more, the display device having a low discharge voltage, good efficiency, and a low circuit cost can be fabricated by using the present invention.

Further, while the power consumption is increased in the plasma display configured by 700 or more pixel lines due to the increase of the number of cells, a display device suppressing power consumption can be fabricated by using the present invention.

Moreover, the PDP can be fabricated similarly even by the phosphors having respective compositions shown below as the red, green, and blue phosphors.

In the red phosphor, a phosphor of any one or more of (Y,Gd)BO₃:Eu, (Y,Gd)₂O₃:Eu, and (Y,Gd) (P,V)O₄:Eu may be contained. In the green phosphor, a phosphor of any one or more of YBO₃:Tb, (Y,Gd)BO₃:Tb, BaMgAl₁₄O₂₃:Mn, and BaAl₁₂O₁₉:Mn may be contained. In the blue phosphor, blue phosphors of one or more selected from a group of CaMgSi₂O₆:Eu, Ca₃MgSi₂O:Eu, Ba₃MgSi₂O₈:Eu, and Sr₃MgSi₂O₈:Eu may be contained.

The phosphors cited above are examples of phosphors generally used. The effect of the present invention is effective regardless of kinds of the phosphors used. Even when the phosphors other than those cited above are used, the display device of the present invention can be fabricated.

### SECOND EMBODIMENT

While the description in the first embodiment has been made on the case where the material (for example, CaAl₂O₄) satisfying the requirements of the present invention is mixed with the phosphors of red, green, and blue colors for performing the display to form the phosphor layer, a description in the present embodiment will be made on the case where a predetermined amount of phosphors is directly coated on side surface of a barrier rib. Note that, other than that, the basic structure, phosphor materials, manufacturing method, and the PDP device 200 using the PDP 100 are the same as those of the first embodiment, and therefore, the descriptions thereof will be omitted.

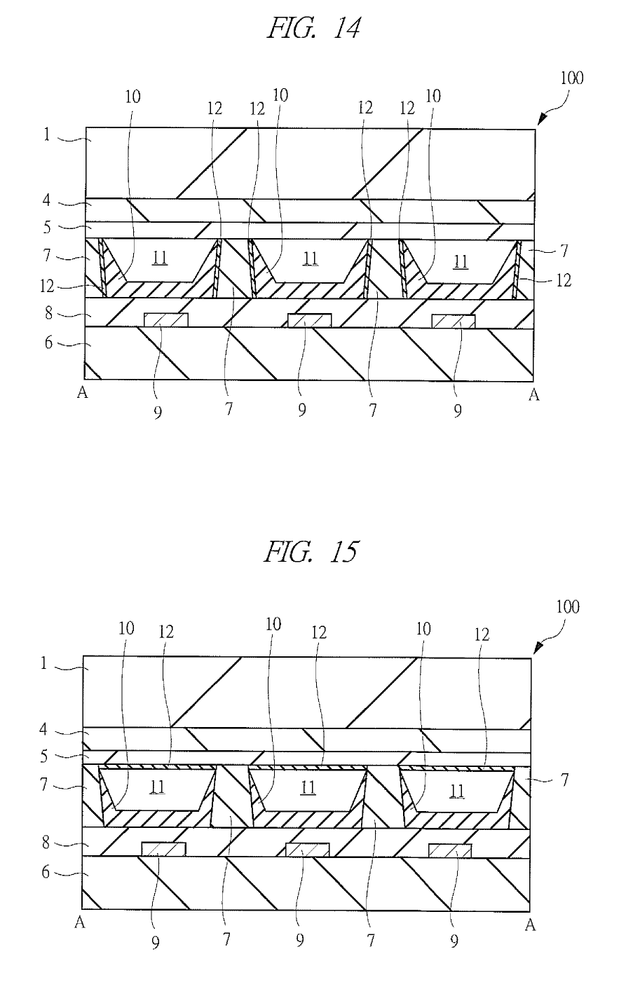

FIG. 14 is a cross-sectional view of main pars of the PDP 100 in the present embodiment corresponding to the line A-A of FIG. 1. As shown in FIG. 14, a predetermined amount of a material 12 (for example, CaAl₂O₄) satisfying the requirements of the present invention is applied on side surfaces of the barrier rib 7. Thereby, the PDP 100 and the PDP device 200 using the same in the present embodiment can display good characteristics same as those of the first embodiment.

### THIRD EMBODIMENT

While, the descriptions in the first and second embodiments have been made on the case where the material (for example, CaAl₂O₄) satisfying the requirements of the present invention is mixed with the phosphors of red, green, and blue colors for performing the display to form the phosphor layer, a description in the present embodiment will be made on the case where a predetermined amount of the material is directly applied on a part of a protective film. Other than that, the basic structure, phosphor materials, manufacturing method, and the PDP device 200 using the PDP 100 are same as those of the first embodiment, and therefore, the descriptions thereof will be omitted.

FIG. 15 is a cross-sectional view of main parts of the PDP 100 in the present embodiment corresponding to the line A-A of FIG. 1. As shown in FIG. 15, a predetermined amount of the material 12 (for example, CaAl₂O₄) satisfying the requirements of the present invention is applied on a part of the protective film 5. Thereby, the PDP 100 and the PDP device 200 using the same in the present embodiment can display good characteristics same as those of the first embodiment.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, while descriptions have been made on the case where the structure of the barrier rib is a stripe type applied to an AC surface discharge type PDP, a box type is also applicable.

The present invention is effective for display devices, particularly for a PDP device. In particular, the present invention can be widely used for the PDP manufacturing industry.

What is claimed is:

1. A display device in which a front plate and a rear plate arranged opposing to each other to form a discharge space and a discharge gas is filled inside the discharge space, the display device comprising:
at least one pair of electrodes for performing a display discharge; and
a phosphor layer for emitting visible light by ultraviolet ray emission by the discharge of the discharge gas, wherein
a material to which charges are accumulated by voltage application or by light irradiation is contained inside the discharge space.

2. The display device according to claim 1, wherein the material emits electrons.

3. The display device according to claim 1, wherein
at least a part of the accumulated charges is held in the material for a period of time longer than or equal to a pulse duration of a driving voltage waveform.

4. The display device according to claim 1, wherein
at least a part of the accumulated charges is held for a period of time longer than or equal to 2 μs of a driving voltage waveform.

5. A display device in which a front plate and a rear plate arranged opposing to each other to form a discharge space and a discharge gas is filled inside the discharge space, the display device comprising:
at least one pair of electrodes for performing a display discharge; and
a phosphor layer for emitting visible light by ultraviolet ray emission by the discharge of the discharge gas, wherein
a material whose main composition is expressed by CaAl₂O₄ is contained inside the discharge space.

6. The display device according to claim 5, wherein
a crystal system of a main crystal phase of the material is monoclinic and in a space group P21, and a diffraction line having the highest intensity in an X-ray diffraction by CuKα-ray of the material appears in the vicinity of 2θ=30°.

7. The display device according to claim 1, wherein
a material whose main composition contains aluminum oxychloride of a group IIa metal and/or a group IIb metal is at least partly contained as the material to which charges are accumulated by voltage application or by light irradiation.

8. The display device according to claim 1, wherein
a material whose main composition is expressed by MAI₂O₄, where M is at least one element out of Mg, Ca, Zn, and Sr, is contained as the material to which charges are accumulated by voltage application or by light irradiation.

9. The display device according to claim 1, wherein
a quantum efficiency of a visible light emission in a range of 450 nm to 780 nm made by irradiation of ultraviolet light of smaller than or equal to 450 nm of the material is smaller than or equal to 15%.

10. The display device according to claim 1, wherein
a material whose main composition contains aluminum oxychloride of a group IIa metal and/or a group IIb metal is at least partly contained as the material to which charges are accumulated by voltage application or by light irradiation, and
a quantum efficiency of a visible light emission in a range of 450 nm to 780 nm made by irradiation of ultraviolet light of smaller than or equal to 450 nm of the material is smaller than or equal to 15%.

11. The display device according to claim 5, wherein
a crystal system of a main crystal phase of the material is monoclinic and in the space group P21,
a diffraction line having the highest intensity in an X-ray diffraction by CuKα-ray of the material appears in the vicinity of 2θ=30°, and
a quantum efficiency of a visible light emission in a range of 450 nm to 780 nm made by irradiation of ultraviolet light of smaller than or equal to 450 nm of the material is smaller than or equal to 15%.

12. The display device according to claim 5, wherein
a quantum efficiency of a visible light emission in a range of 450 nm to 780 nm made by irradiation of ultraviolet light of smaller than or equal to 450 nm of the material is smaller than or equal to 15%.

13. The display device according to claim 1, wherein
a material whose main composition is expressed by MAI₂O₄, where M is at least one element out of Mg, Ca, Zn, and Sr, is contained as the material to which charges are accumulated by voltage application or by light irradiation, and
a quantum efficiency of a visible light emission in a range of 450 nm to 780 nm made by irradiation of ultraviolet light of smaller than or equal to 450 nm of the material is smaller than or equal to 15%.

14. The display device according to claim 1, wherein
a weight of the material existing inside the discharge space is not less than 0.1% and not more than 50% of a total sum of weights of phosphors provided inside the discharge space.

15. The display device according to claim 1, wherein
a weight of the material existing inside the discharge space is not less than 0.1% and not more than 20% of a total sum of weights of phosphors provided inside the discharge space.

16. The display device according to claim 1, wherein
a weight of the material existing inside the discharge space is not less than 1 mg and not more than 220 mg per a panel area of 100 cm².

17. The display device according to claim 1, wherein
the material is present in the phosphor layer inside the discharge space.

18. The display device according to claim 1, wherein
the material is provided to a barrier rib on the rear plate and/or to a protective film on the front plate inside the discharge space.

19. The display device according to claim 1, wherein
the display device is a plasma display device containing a gas containing Xe gas whose composition ratio in the discharge gas is larger than or equal to 8%.

20. The display device according to claim 1, wherein
the display device is a plasma display device configured with 700 or more display pixel lines.

21. A plasma display panel comprising a discharge space between a front plate and a rear plate opposing to each other is sectioned by barrier ribs provided on the rear plate, wherein
the discharge space is filled with a discharge gas,
the front plate includes a first substrate, a pair of display electrodes provided on the first substrate, and a first dielectric layer covering the pair of display electrodes,
the rear plate includes a second substrate, an address electrode provided on the second substrate, a second dielectric layer covering the address electrode, the barrier rib provided on the second dielectric layer, and a phosphor layer contacted with the discharge space and provided on the second dielectric layer, and
the phosphor layer is formed of a phosphor containing CaAl₂O₄.
